(19) United States
(12) Patent Application Publication
(10) Pub. No.: US 2021/0173059 A1
(43) Pub. Date: Jun. 10, 2021

(54) LIDAR SENSOR

(71) Applicant: Infineon Technologies AG, Neubiberg (DE)

(72) Inventor: Boris KIRILLOV, Judendorf-Straßenge (AT)

(73) Assignee: Infineon Technologies AG, Neubiberg (DE)

(21) Appl. No.: 17/095,342

(22) Filed: Nov. 11, 2020

(30) Foreign Application Priority Data
Dec. 5, 2019 (DE) 102019133135.8

(51) Int. Cl. G01S 7/4912; G01S 7/4913; G02B 26/08; G02B 26/10

(52) U.S. Cl. CPC G01S 7/4918; G01S 7/4917; G02B 26/101; G02B 26/0841; G01S 7/4913

(57) ABSTRACT

A LIDAR sensor includes a linear array of light sources each configured to controllably emit a respective light beam for scanning an environment in a field of view; a deflection system configured to deflect the light beams into the field of view according to a two-dimensional scan pattern; and a control circuit configured to selectively control emission times of the light sources. The control circuit is configured to always control the light sources to simultaneously or sequentially emit their respective light beam. The light beams illuminate a strip-shaped sub-portion of the field of view when all of the light sources are controlled to simultaneously or sequentially emit their respective light beam. The strip-shaped sub-portion longitudinally extends along a spatial axis, wherein an extension of the strip-shaped sub-portion along the spatial axis is smaller than an extension of the field of view along the spatial axis.

### FIELD

The present disclosure relates to light detection and ranging (LIDAR). In particular, examples relate to a LIDAR sensor.

### BACKGROUND

In a scanning LIDAR architecture, an environment is scanned using laser light. The laser light is reflected by objects in the environment. The time from emitting laser light from the LIDAR system to receiving the light reflected from an object is used to generate a 3D image.

In conventional two-dimensional LIDAR scanning, light of single laser is deflected two-dimensionally in order to subsequently illuminate small spots in the environment. Conventional two-dimensional LIDAR scanning provides only limited frame rates.

### SUMMARY

Hence, there may be a demand for improved LIDAR sensing.

The demand may be satisfied by the subject matter of the appended claims.

An example relates to a LIDAR sensor. The LIDAR sensor includes a linear array of light sources each configured to controllably emit a respective light beam for scanning an environment in a Field of View (FoV). Further, the LIDAR sensor includes a deflection system configured to deflect the light beams into the FoV according to a two-dimensional scan pattern. The LIDAR sensor additionally includes a control circuit configured to selectively control emission times of the light sources. The control circuit is configured to always control the light sources to simultaneously or sequentially emit their respective light beam. The light beams illuminate a strip-shaped sub-portion of the FoV when all of the light sources are controlled to simultaneously or sequentially emit their respective light beam. The strip-shaped sub-portion longitudinally extends along a spatial axis, wherein an extension of the strip-shaped sub-portion along the spatial axis is smaller than an extension of the FoV along the spatial axis.

### BRIEF DESCRIPTION OF THE DRAWINGS

Some examples of apparatuses and/or methods will be described in the following by way of example only, and with reference to the accompanying figures, in which

FIG. 1 illustrates an example of a LIDAR sensor;

FIG. 2 illustrates an example of a two-dimensional scan pattern;

FIG. 3 illustrates an example of a Lissajous pattern;

FIG. 4 illustrates an example of an entirely scanned field of view (FoV);

FIG. 5 illustrates an example of a second scanning scheme;

FIG. 6 illustrates an example of a third scanning scheme;

FIG. 7 illustrates an example of a fourth scanning scheme;

FIG. 8 illustrates an example of a fifth scanning scheme; and

FIG. 9 illustrates an example of a sixth scanning scheme.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Same or like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled via one or more intervening elements. If two elements A and B are combined using an “or”, this is to be understood to disclose all possible combinations, i.e. only A, only B as well as A and B, if not explicitly or implicitly defined otherwise. An alternative wording for the same combinations is “at least one of A and B” or “A and/or B”. The same applies, mutatis mutandis, for combinations of more than two Elements.

The terminology used herein for the purpose of describing particular examples is not intended to be limiting for further examples. Whenever a singular form such as “a”, “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises”, “comprising”, “includes” and/or “including”, when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

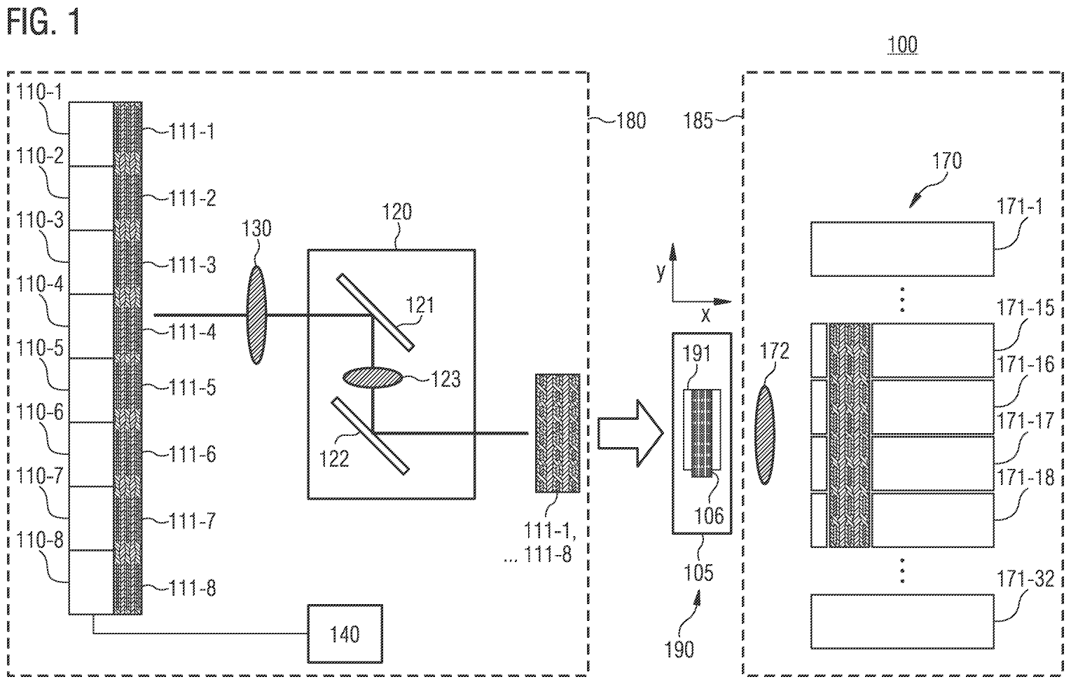

FIG. 1 illustrates a LIDAR sensor 100 as an example of a Time-of-Flight (ToF) range finder for sensing an environment 190. The LIDAR sensor 100 exhibits a FoV 105 defining the extent of the environment 190 that is observable by the LIDAR sensor 100 at a given time instant. An optical transmitter section 180 of the LIDAR sensor 100 is illustrated in the left part of FIG. 1, whereas an optical receiver section 185 of the LIDAR sensor 100 is illustrated in the right part of FIG. 1. In order to illustrate the LIDAR sensing process, the FoV 105 is depicted between the optical transmitter section 180 and the optical receiver section 185. It is to be noted that the distributed depiction of the LIDAR sensor 100 in FIG. 1 is selected merely for a better understanding in order to illustrate the LIDAR sensing process, and that the arrangements of the optical transmitter section 180 and the optical receiver section 185 with respect to each other may be different from what is shown in FIG. 1.

The LIDAR sensor 100 comprises a linear array of light sources 110-1, . . . , 110-8 each configured to controllably emit a respective light beam 111-1, . . . , 111-8 for scanning the environment in the FoV 105. For example, the light beams 111-1, . . . , 111-8 may be laser light beams. The laser light beams 111-1, . . . , 111-8 may be pulsed. For example, a pulse repetition frequency may be between 10 and 200 kHz. In some examples, the light beams 111-1, . . . , 111-8 may be infrared light beams. The linear array of light sources 110-1, . . . , 110-8 may, e.g., be a multi-channel edge emitter laser comprising a plurality of laser channels constituting the individual light sources 110-1, . . . , 110-8. In the example of FIG. 1, a linear array of eight light sources 110-1, . . . , 110-8 is illustrated. However, it is to be noted that proposed technique is not limited to a linear array of eight light sources. In general, any linear array comprising L≥2 light sources may be used.

Further, the LIDAR sensor 100 comprises a deflection system 120 configured to deflect the light beams 111-1, . . . , 111-8 into the FoV 105 according to a two-dimensional scan pattern. In other words, the light beams 111-1, . . . , 111-8 are deflected such by the deflection system 120 that they illuminate the FoV 105 according to the two-dimensional scan pattern.

In the example of FIG. 1, the deflection system 120 comprises two reflective surfaces for deflecting the light beams 111-1, . . . , 111-8. A first reflective surface 121 is configured to oscillate about a first rotation axis. That is, the first reflective surface 121 rotates about the first rotation axis along a first rotation direction from a first end position to a second end position, and vice versa (i.e. along a reverse second rotation direction from the second end position to the first end position). For example, the oscillation movement of the first reflective surface 121 may comprise rotations along both rotation directions between 2° and 45°. For example, the first reflective surface 121 may oscillate about the first rotation axis at frequencies between 10 Hz and 100 kHz (e.g. at 2.5 kHz). The first reflective surface 121 may be implemented in many different ways. In some examples, the first reflective surface 121 may be a MEMS (MicroElectroMechanical System) mirror. Similarly, a second reflective surface 122 is configured to oscillate about a second rotation axis (e.g. perpendicular to the first rotation axis). The first reflective surface 121 deflects the light beams 111-1, . . . , 111-8 onto the second reflective surface 122, and the second reflective surface 122 deflects the light beams 111-1, . . . , 111-8 into the environment 190.

As indicated in FIG. 1, the deflection system 120 may optionally comprise further elements such as e.g. an additional optical system 123 (e.g. a lens system comprising one or more optical lenses) for relaying the light beams 111-1, . . . , 111-8 from the first reflective surface 121 to the second reflective surface 122.

In alternative examples, the deflection system 120 may comprise a single reflective surface configured to oscillate about a first rotation axis and a second rotation axis (e.g. perpendicular to the first rotation axis) for deflecting the light beams 111-1, . . . , 111-8 into the environment 190. For example, the single reflective surface may be supported by a gimbal for enabling the reflective surface to oscillate about the first rotation axis and the second rotation axis.

The LIDAR sensor 100 may optionally further comprise an optical system 130 (e.g. a lens system comprising one or more optical lenses) arranged between the array of light sources 110-1, . . . , 110-8 and the deflection system 120. The optical system 130 is configured to collimate and focus the light beams 111-1, . . . , 111-8.

The LIDAR sensor 100 additionally comprises a control circuit 140 for controlling operation of the light sources 110-1, . . . , 110-8 (and optionally the deflection system 120). In particular, the control circuit 140 is configured to selectively control emission times of the light sources 110-1, . . . , 110-8. For example, the control circuit 140 may be a single dedicated processor, a single shared processor, or a plurality of individual processors, some of which or all of which may be shared, a digital signal processor (DSP) hardware, an application specific integrated circuit (ASIC) or a field programmable gate array (FPGA). The control circuit 140 may optionally be coupled to, e.g., read only memory (ROM) for storing software, random access memory (RAM) and/or non-volatile memory.

As indicated in FIG. 1, the light beams 111-1, . . . , 111-8 illuminate a strip-shaped sub-portion 106 of the FoV 105 when all of the light sources 111-1, . . . , 111-8 are controlled to simultaneously emit their respective light beam. The strip-shaped sub-portion 106 longitudinally extends along a spatial axis y. In other words, the extension of the illuminated strip-shaped sub-portion 106 of the FoV 105 along the spatial axis y is much (e.g. at least 2, 5, 10, 20 or 50 times) greater than the extension of the illuminated strip-shaped sub-portion 106 of the FoV 105 along another spatial axis x, which is perpendicular to the spatial axis y. The extension of the illuminated strip-shaped sub-portion 106 of the FoV 105 along the spatial axis y is smaller than an extension of the FoV 105 along the spatial axis y. In other words, the strip-shaped sub-portion 106 of the FoV 105 does not entirely cover the FoV along the spatial axis y. Further, the extension of the illuminated strip-shaped sub-portion 106 of the FoV 105 along the other spatial axis x is smaller much (e.g. at least 5, 10, 20 or 50 times) than the extension of the FoV 105 along the spatial axis x.

The control circuit 140 is configured to always control (e.g. at least one of or at least two of) the light sources 110-1, . . . , 110-8 to simultaneously or sequentially emit their respective light beam 111-1, . . . , 111-8 such that at least a sub-portion of the strip-shaped sub-portion 106 of the FoV 105 is illuminated by the LIDAR sensor 100 for scanning the environment in the FoV 105. Therefore, in some examples, two or more of the light sources 110-1, . . . , 110-8 are always fired together.

Due to the oscillatory movement of the reflective surfaces 121 and 122, the light beams 111-1, . . . , 111-8 may be emitted at different transmission angles to the environment 190. By controlling the emission times of the light sources 110-1, . . . , 110-8, the transmission angles of the light beams 111-1, . . . , 111-8 may be controlled in order to scan the full FoV 105. In other words, over time the strip-shaped sub-portion 106 of the FoV 105 which is at least in part illuminated may be moved in a two-dimensional manner over the FoV 105 in order to scan the full FoV 105. Compared to conventional two-dimensional LIDAR scan approaches illuminating only a single small spot of the FoV 105, the FoV 105 may be scanned at a higher framerate by the LIDAR sensor 100 since the at least in part illuminated strip-shaped sub-portion 106 of the FoV 105 scans a larger fraction of the FoV 105 at a time compared to the conventional scan approaches.

The light beams 111-1, . . . , 111-8 are reflected by objects in the FoV 105 such as the exemplary object 191. The reflections from the FoV 105 are received and detected by the optical receiver section 185 of the LIDAR sensor 100.

The optical receiver section 185 comprises a photodetector 170 capable of receiving reflections of the light beams 111-1, . . . , 111-8 from the environment 190. The photodetector 170 is either a one-dimensional array of light-sensitive sensor elements 171-1, . . . , 171-32 as illustrated in FIG. 1 or a two-dimensional array of light-sensitive sensor elements. In other words, the light-sensitive sensor elements may be arranged either along a single spatial direction as illustrated in FIG. 1 (e.g. along spatial axis y) or along two different (e.g. orthogonal) spatial directions (e.g. spatial axes x and y). For example, a light-sensitive sensor element may be a photo diode, an Avalanche Photo Diode (APD), a Single Photon Avalanche Diode (SPAD), or an array of SPADs as Silicon PhotoMultipliers (SiPM). In the example of FIG. 1, the photodetector 170 comprises 32 light-sensitive sensor elements 171-1, . . . , 171-32. However, it is to be noted that proposed technique is not limited to a photodetector comprising 32 light-sensitive sensor elements. In general, any number M≥2 of light-sensitive sensor elements may be used for the photodetector 170.

As indicated in FIG. 1, the optical receiver section 185 may optionally comprise further elements such as e.g. a further optical system 172 (e.g. a lens system comprising one or more optical lenses) for focusing the reflections of the light beams 111-1, . . . , 111-8 from the environment 190 onto the photodetector 170.

The LIDAR sensor 100 may further comprise other hardware —conventional and/or custom.

In some examples, the control circuit 140 is configured to control the emission times of the light sources 110-1, . . . , 110-8 such that all of the light sources 110-1, . . . , 110-8 simultaneously emit their respective light beam for illuminating the strip-shaped sub-portion 106 of the FoV 105.

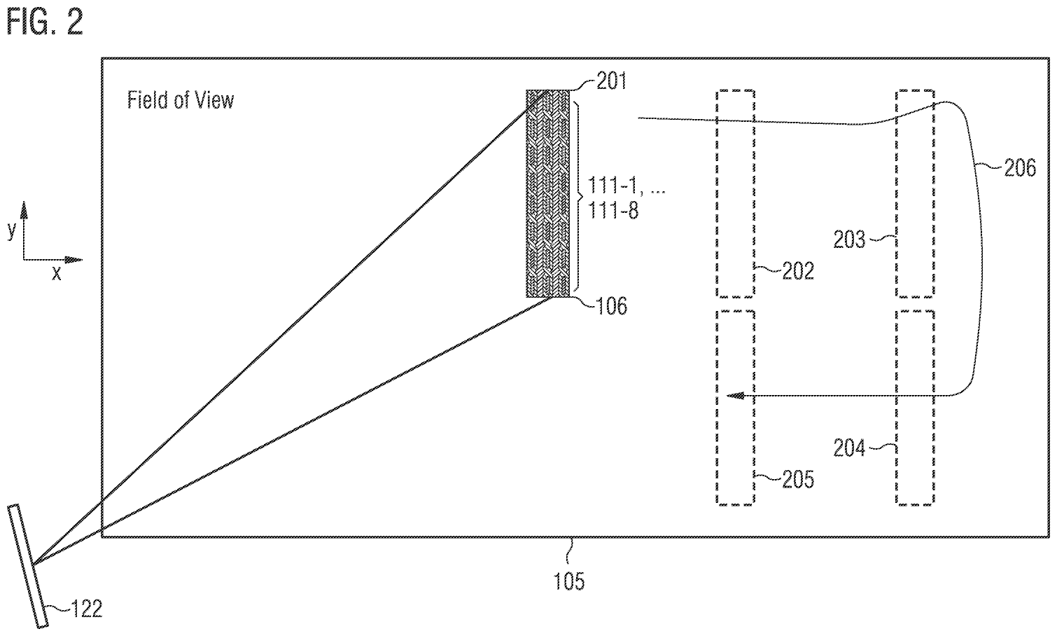

An exemplary two-dimensional pattern for scanning the FoV 105 using the fully illuminated strip-shaped sub-portion 106 of the FoV 105 is illustrated in FIG. 2. As indicated in FIG. 2, by positions 201, . . . , 205 and the motion line 206, the strip-shaped sub-portion 106 of the FoV 105 formed by the light beams 111-1, . . . , 111-8 moves in a two-dimensional manner over the FoV 105 in order to scan the full FoV 105.

As indicated by the motion line 206 and the positions 201 to 203, the light beams 111-1, . . . , 111-8 initially illuminate the FoV 105 at a constant first position along the spatial axis y and at varying positions along the other spatial axis x. Subsequently, as indicated by the motion line 206 and the positions 204 and 205, the light beams 111-1, . . . , 111-8 illuminate the FoV 105 at a constant second position along the spatial axis y and at varying positions along the other spatial axis x, wherein the second position is shifted with respect to the first position along the spatial axis y. In other words, the light beams 111-1, . . . , 111-8 scan the FoV 105 horizontally line by line until the entire FoV 105 is scanned.

The number of light-sensitive sensor elements capable of receiving (configured to receive) reflections from the strip-shaped sub-portion 106 of the FoV 105 may be smaller than the number of light sources 110-1, . . . , 110-8. For example, the number of light sources 110-1, . . . , 110-8 in the linear array of light sources 110-1, . . . , 110-8 may be an integer multiple of the number of light-sensitive sensor elements capable of receiving reflections from the strip-shaped sub-portion 106 of the FoV 105. This is indicated in FIG. 1. The light beams 111-1, . . . , 111-8 emitted by the eight light sources 110-1, . . . , 110-8 is reflected by the object 191 in the FoV 105. Only the four light-sensitive sensor elements 171-15, 171-16, 171-17 and 171-18 are capable of receiving reflections from the solid angle in which the object 191 is located. In other words, eight light sources fire the light beams into only four light-sensitive sensor elements. Accordingly, each of the four light-sensitive sensor elements 171-15, 171-16, 171-17 and 171-18 receives reflected light beams from two of the eight light sources 110-1, . . . , 110-8. That is, the eight light sources shoot/fire in an interleaved manner.

The optical system 130 together with the deflection system 120 may allow to collimate and focus the light beams 111-1, . . . , 111-8 of the light sources 110-1, . . . , 110-8 such that the resulting collimated and focused beam exhibits a desired beam angle. For example, the resulting beam for the eight light sources 110-1, . . . , 110-8 may exhibit a beam angle of 0.2°×4° or 0.5°×4° (along the spatial axes z and y, wherein the spatial axis z is perpendicular to the spatial axes x and y). Accordingly, the power of the light beams 111-1, . . . , 111-8 may be collimated and concentrated in a desired beam angle.

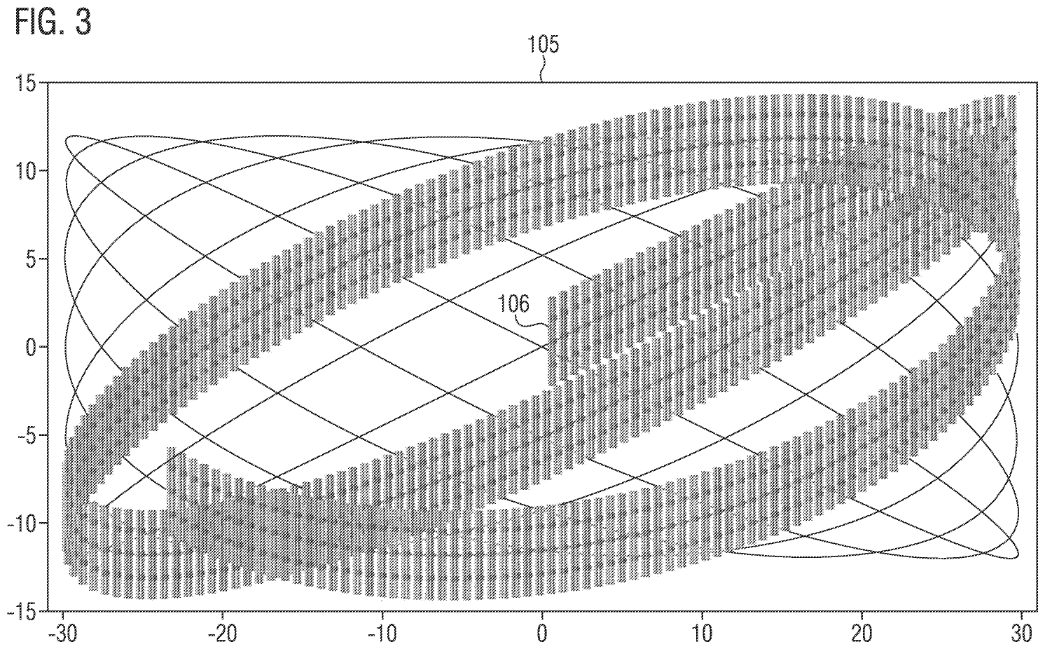

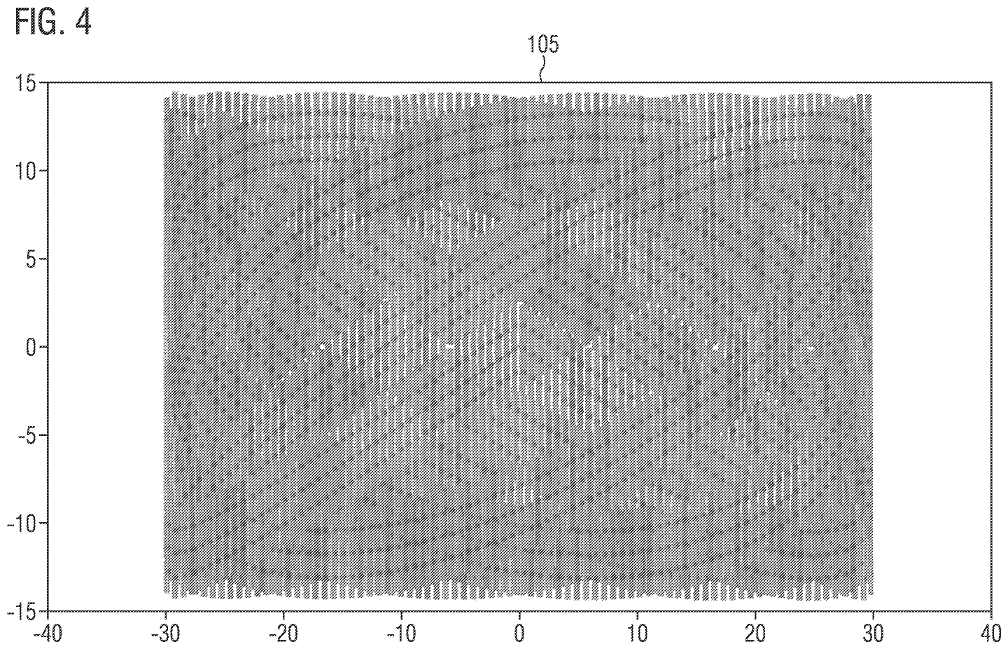

FIGS. 3 and 4 illustrate another exemplary two-dimensional scan pattern. In the example of FIGS. 3 and 4, the two-dimensional scan pattern is a Lissajous pattern.

FIG. 3 illustrates again the FoV 105. In the example of FIG. 3, a horizontal coverage of the FoV 105 is 60° and a vertical coverage of the FoV 105 is 30°. However, it is to be noted that the proposed technique may in general be used for any FoV coverage.

As can be seen from FIG. 3, the strip-shaped sub-portion 106 of the FoV 105 formed by the light beams 111-1, . . . , 111-8 moves along a Lissajous curve over the FoV 105.

FIG. 4 illustrates the FoV 105 after a complete scan using the Lissajous pattern.

Combining the of light beams 111-1, . . . , 111-8 of the eight light sources 110-1, . . . , 110-8 to a strip-shaped/rectangular laser beam and using the sparse Lissajous pattern as illustrated in FIGS. 3 and 4 may allow to achieve significantly higher frame rates compared to conventional two-dimensional LIDAR scanning approaches.

The frame rate a is given by the following mathematical expression:

$$a = \frac{2 \cdot f}{π} \cdot \frac{b}{c - b} \qquad ( 1 )$$

f denotes the oscillation frequency of the reflective surfaces 121 and 122, b denotes the beam size of the combined beam of the eight light sources 110-1, . . . , 110-8 along the spatial axis y (i.e. the vertical size of the combined beam), and c de notes the extension of the FoV 105 along the spatial axis y (i.e. the vertical size of the FoV 105).

For example, assuming an oscillation frequency f=2000 Hz, a vertical beam size b=5° and a vertical size of the FoV 105 of c=30°, the frame rate is a=255 Hz.

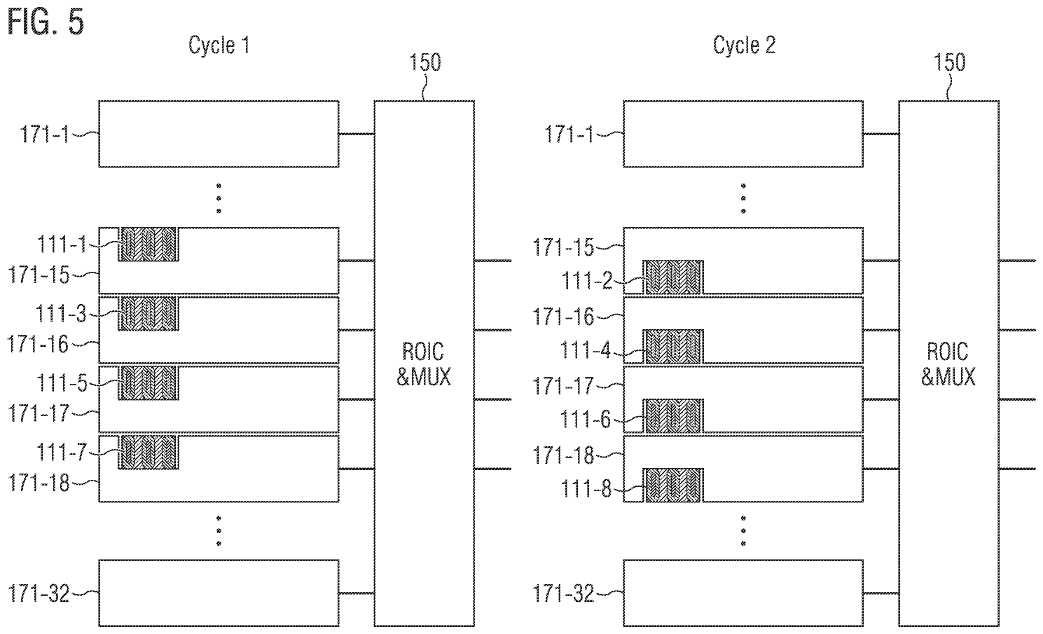

Another scan approach is illustrated in FIG. 5 and will be described in the following in connection with the LIDAR sensor 100 as illustrated in FIG. 1. FIG. 5 illustrates the photodetector 170 and the received reflections from the environment 190 in the FoV 105 for two consecutive scan cycles.

The control circuit 140 is configured to control the emission times of the light sources 110-1, . . . , 110-8 such that during the first scan cycle only the light sources at odd positions of the linear array of light sources 110-1, . . . , 110-8 simultaneously emit their respective light beam for illuminating first sub-portions of the strip-shaped sub-portion 106 of the FoV 105. In other words, the control circuit 140 controls only the light sources 110-1, 110-3, 110-5 and 110-7 to simultaneously emit their respective light beam 111-1, 111-3, 111-5, 111-7 during the first scan cycle. Accordingly, the first sub-portions of the strip-shaped sub-portion 106 of the FoV 105 are illuminated during the first scan cycle.

During the second scan cycle, the control circuit 140 controls the emission times of the light sources 110-1, . . . , 110-8 such that only the light sources at even positions of the linear array of light sources 110-1, . . . , 110-8 simultaneously emit their respective light beam for illuminating second sub-portions of the strip-shaped sub-portion 106 of the FoV. In other words, the control circuit 140 controls only the light sources 110-2, 110-4, 110-6 and 110-8 to simultaneously emit their respective light beam 111-2, 111-4, 111-6, 111-8 during the second scan cycle. Accordingly, the second sub-portions of the strip-shaped sub-portion 106 of the FoV 105 are illuminated during the second scan cycle.

Only the four light-sensitive sensor elements 171-15, 171-16, 171-17 and 171-18 are capable of receiving (configured to receive) reflections from the solid angle in which the object 191, which is reflecting the light beams of the individual light sources fired during the two scan cycles, is located.

Each of the four light-sensitive sensor elements 171-15, 171-16, 171-17 and 171-18 receives a reflection from a respective one of the first sub-portions of the strip-shaped sub-portion 106 of the FoV 105 during the first scan cycle. In particular, each of the four light-sensitive sensor elements 171-15, 171-16, 171-17 and 171-18 receives a reflection of one of the light beams 111-1, 111-3, 111-5, 111-7 from the object 191 during the first scan cycle.

Similarly, each of the four light-sensitive sensor elements 171-15, 171-16, 171-17 and 171-18 receives a reflection from a respective one of the second sub-portions of the strip-shaped sub-portion 106 of the FoV 105 during the second scan cycle. In particular, each of the four light-sensitive sensor elements 171-15, 171-16, 171-17 and 171-18 receives a reflection of one of the light beams 111-2, 111-4, 111-6, 111-8 from the object 191 during the second scan cycle.

The light-sensitive sensor elements 171-1, . . . , 171-32 are coupled to a read-out circuit 150, which is configured to read out the light-sensitive sensor elements 171-15, 171-16, 171-17 and 171-18, which are capable of receiving the reflections from the strip-shaped portion 106 of the FoV 105, in parallel. In other words, the four light-sensitive sensor elements 171-15, 171-16, 171-17 and 171-18 are read-out in parallel.

As can be seem from FIG. 5, each of the light-sensitive sensor elements 171-15, 171-16, 171-17 and 171-18 is used twice for read-out of shots from two different light sources. Assuming that each of the light-sensitive sensor elements 171-1, . . . , 171-32 covers an angle of 1° along the spatial axis y (e.g. a vertical angle of 1°), the total resolution of the photodetector 170 along the spatial axis y is 32°. Since each of the light-sensitive sensor elements 171-15, 171-16, 171-17 and 171-18 is used twice, the effective resolution of the photodetector 170 along the spatial axis y is 32°/(32/2)=0.5°. In other words, the resolution of the photodetector 170 along the spatial axis y is boosted twice.

The light power per light-sensitive sensor element is boosted by collimating and focusing the light beam to a desired beam angle (e.g. 0.5°×4° for the eight light sources 110-1, . . . , 110-8 illustrated in FIG. 1).

By reading out the four light-sensitive sensor elements 171-15, 171-16, 171-17 and 171-18 in parallel during each scan cycle, the budget for averaging is four times higher compared to conventional single point two-dimensional scan patterns. Further, there is enough parallelism in the system for addressing each point several times for improved range performance.

In the example of FIG. 5, each of four light-sensitive sensor elements 171-15, 171-16, 171-17 and 171-18 “sees” the light beams of two of the light sources 110-1, . . . , 110-8 in two consecutive scan cycles. However, the proposed technique is not limited thereto. In some examples, a different number of light sources and/or light-sensitive sensor elements may be used. Further, each of the light-sensitive elements may “see” the light beams of more than two of the light sources in consecutive scan cycles.

For example, a linear array of nine light sources may be used, wherein the light sources at the positions 1, 4 and 7 of the linear array are fired during a first scan cycle, the light sources at the positions 2, 5 and 8 of the linear array are fired during a second scan cycle, and the light sources at the positions 3, 6 and 9 of the linear array are fired during a third scan cycle. Three light-sensitive sensor elements may, e.g., be capable of receiving reflections of the light beams emitted by the nine light sources. For example, the first of the three light-sensitive sensor elements may receive the reflected light beam of the light sources at the position 1 during the first scan cycle, the reflected light beam of the light sources at the position 2 during the second scan cycle, and the reflected light beam of the light sources at the position 3 during the third scan cycle. Similarly, the second one of the three light-sensitive sensor elements may consecutively receive the reflected light beams of the light sources at the positions 4, 5 and 6 during the three scan cycles, and the third one of the three light-sensitive sensor elements may consecutively receive the reflected light beams of the light sources at the positions 7, 8 and 9 during the three scan cycles.

Speaking more general, the control circuit 140 may be configured to control the emission times of the light sources such that during a first scan cycle only a first subset of light sources of the linear array of light sources simultaneously emits their respective light beam for illuminating first sub-portions of the strip-shaped sub-portion 106 of the FoV 105, that during a second scan cycle only a second subset of light sources of the linear array of light sources simultaneously emits their respective light beam for illuminating second sub-portions of the strip-shaped sub-portion 106 of the FoV 105, etc. A predefined number N of light sources of the linear array of light sources is arranged between each pair of consecutive light sources of the first subset of light sources, each pair of consecutive light sources of the second subset of light sources, etc. (e.g. one, two or more light sources may be arranged between each pair of consecutive lights of the subsets). The light sources of the first subset of light sources are different from the light sources of the second subset of light sources. In other words, the first subset of light sources does not comprise a light source of the second subset of light sources, and vice versa. Similarly, the light sources of potential further subsets of light sources are different from each other and from those of the first and the second subset of light sources.

Accordingly, the number of light sources in the linear array of light sources is larger than (e.g. N+1 times) the number of light-sensitive sensor elements capable of receiving (configured to receive) reflections from the strip-shaped sub-portion 106 of the FoV 105 at a time. Accordingly, each of the number of light-sensitive sensor elements is configured to receive reflections from a respective one of the first sub-portions of the strip-shaped sub-portion 106 of the FoV 105 during the first scan cycle, and from a respective one of the second sub-portions of the strip-shaped sub-portion 106 of the FoV 105 during the second scan cycle.

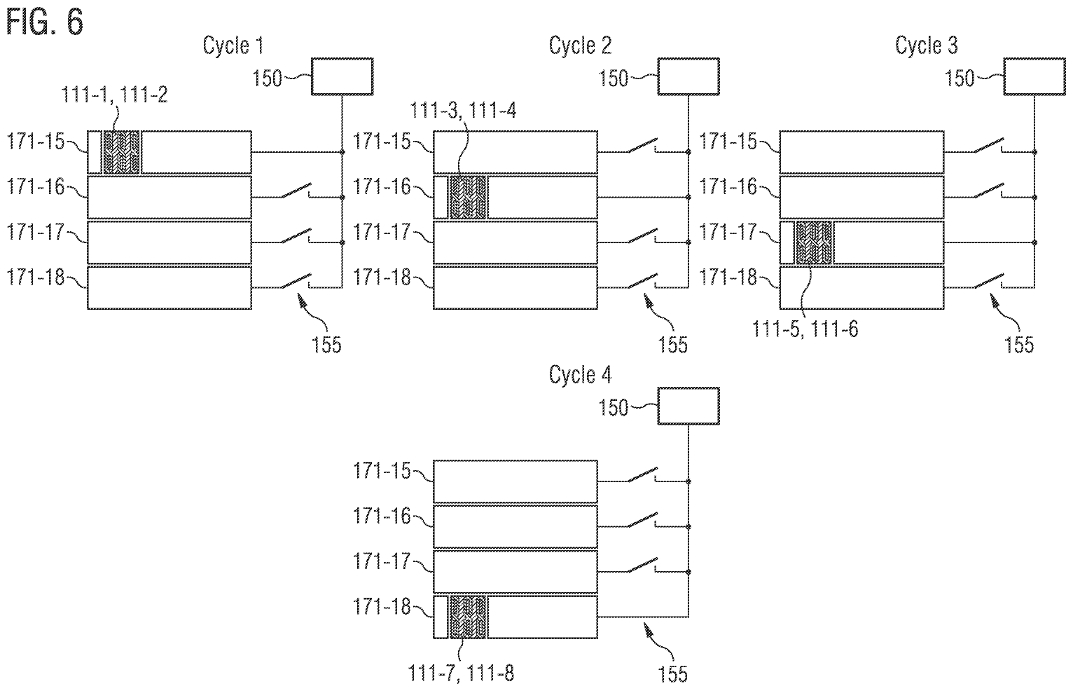

FIG. 6 illustrates another scan approach which will be described in the following in connection with the LIDAR sensor 100 as illustrated in FIG. 1. FIG. 6 illustrates the photodetector 170 and the received reflections from the environment 190 in the FoV 105 for four consecutive scan cycles.

In the example of FIG. 6, the control circuit 140 is configured to control the emission times 140 of the light sources 110-1, . . . , 110-8 such that during a first scan cycle only a first pair of neighboring light sources 110-1 and 110-2 of the linear array of light sources 110-1, . . . , 110-8 simultaneously emits their respective light beam 111-1, 111-2 for illuminating a first sub-portion of the strip-shaped sub-portion 106 of the FoV 105. In other words, the control circuit 140 controls only the light sources 110-1 and 110-2 to simultaneously emit their respective light beam 111-1, 111-2 during the first scan cycle. Accordingly, the first sub-portion of the strip-shaped sub-portion 106 of the FoV 105 is illuminated during the first scan cycle.

Similarly, the control circuit 140 is configured to control the emission times 140 of the light sources 110-1, . . . , 110-8 such that during a second scan cycle only a second pair of neighboring light sources 110-3 and 110-4 of the linear array of light sources 110-1, . . . , 110-8 simultaneously emits their respective light beam 111-3, 111-4 for illuminating a second sub-portion of the strip-shaped sub-portion 106 of the FoV 105. In other words, the control circuit 140 controls only the light sources 110-3 and 110-4 to simultaneously emit their respective light beam 111-3, 111-4 during the second scan cycle. Accordingly, the second sub-portion of the strip-shaped sub-portion 106 of the FoV 105 is illuminated during the second scan cycle.

Further, the control circuit 140 is configured to control the emission times 140 of the light sources 110-1, . . . , 110-8 such that during a third scan cycle only a third pair of neighboring light sources 110-5 and 110-6 of the linear array of light sources 110-1, . . . , 110-8 simultaneously emits their respective light beam 111-5, 111-6 for illuminating a third sub-portion of the strip-shaped sub-portion 106 of the FoV 105. In other words, the control circuit 140 controls only the light sources 110-5 and 110-6 to simultaneously emit their respective light beam 111-5, 111-6 during the third scan cycle. Accordingly, the third sub-portion of the strip-shaped sub-portion 106 of the FoV 105 is illuminated during the third scan cycle.

The control circuit 140 is additionally configured to control the emission times 140 of the light sources 110-1, . . . , 110-8 such that during a fourth scan cycle only a fourth pair of neighboring light sources 110-7 and 110-8 of the linear array of light sources 110-1, . . . , 110-8 simultaneously emits their respective light beam 111-7, 111-8 for illuminating a fourth sub-portion of the strip-shaped sub-portion 106 of the FoV 105. In other words, the control circuit 140 controls only the light sources 110-7 and 110-8 to simultaneously emit their respective light beam 111-7, 111-8 during the fourth scan cycle. Accordingly, the third sub-portion of the strip-shaped sub-portion 106 of the FoV 105 is illuminated during the fourth scan cycle.

Only the four light-sensitive sensor elements 171-15, 171-16, 171-17 and 171-18 are capable of receiving (configured to receive) reflections from the solid angle in which the object 191, which is reflecting the light beams of the individual light sources fired during the four scan cycles, is located. That is, the number of light-sensitive sensor elements capable of receiving (configured to receive) reflections from the strip-shaped sub-portion 106 of the FoV 105 is half of the (total) number of light sources fired in the four scan cycles.

Each of the of light-sensitive sensor elements 171-15, 171-16, 171-17 and 171-18 is selectively and individually coupleable to a read-out circuit 150 via a switching circuit 155.

As indicated in FIG. 6, only the light-sensitive sensor element 171-15 of the light-sensitive sensor elements 171-15, 171-16, 171-17 and 171-18 is capable of receiving (configured to receive) reflections from the first sub-portion of the strip-shaped sub-portion 106 of the FoV 105. That is, only the light-sensitive sensor element 171-15 receives reflections of the light beams 111-1 and 111-2 from the object 191 during the first scan cycle.

Similarly, only the light-sensitive sensor element 171-16 of the light-sensitive sensor elements 171-15, 171-16, 171-17 and 171-18 is capable of receiving (configured to receive) reflections from the second sub-portion of the strip-shaped sub-portion 106 of the FoV 105. That is, only the light-sensitive sensor element 171-16 receives reflections of the light beams 111-3 and 111-4 from the object 191 during the second scan cycle.

Further, only the light-sensitive sensor element 171-17 of the light-sensitive sensor elements 171-15, 171-16, 171-17 and 171-18 is capable of receiving reflections (configured to receive) from the third sub-portion of the strip-shaped sub-portion 106 of the FoV 105. That is, only the light-sensitive sensor element 171-17 receives reflections of the light beams 111-5 and 111-6 from the object 191 during the third scan cycle.

Only the light-sensitive sensor element 171-18 of the light-sensitive sensor elements 171-15, 171-16, 171-17 and 171-18 is capable of receiving reflections (configured to receive) from the fourth sub-portion of the strip-shaped sub-portion 106 of the FoV 105. That is, only the light-sensitive sensor element 171-18 receives reflections of the light beams 111-7 and 111-8 from the object 191 during the fourth scan cycle.

Therefore, only the light-sensitive sensor elements 171-15 is coupled to the read-out circuit 150 during the first scan cycle, only the light-sensitive sensor element 171-16 is coupled to the read-out circuit 150 during the second scan cycle, only the light-sensitive sensor element 171-17 is coupled to the read-out circuit 150 during the third scan cycle, and only the light-sensitive sensor element 171-18 is coupled to the read-out circuit 150 during the fourth scan cycle.

The read-out option illustrated in FIG. 6 enables an interleaved row-multiplexing with two light sources per light-sensitive sensor element.

In the example of FIG. 6, each of the four light-sensitive sensor elements 171-15, 171-16, 171-17 and 171-18 “sees” the light beams of two of the light sources 110-1, . . . , 110-8 in a respective one of the four scan cycles. However, the proposed technique is not limited thereto. In some examples, a different number of light sources may be used. Further, a different number of light-sensitive sensor elements may be coupled to one read out circuit. Also, each of the light-sensitive elements may “see” the light beams of more than two of the light sources in a scan cycle. For example, three, four or more light beams may be fired onto each light-sensitive sensor element.

Speaking more general, the control circuit 140 may be configured to control the emission times of the light sources such that during a first scan cycle only a first subset of consecutive light sources of the linear array of light sources simultaneously emits their respective light beam for illuminating a first sub-portion of the strip-shaped sub-portion 106 of the FoV 105, and that during a second scan cycle only a second subset of consecutive light sources of the linear array of light sources simultaneously emits their respective light beam for illuminating a second sub-portion of the strip-shaped sub-portion 106 of the FoV 105. The light sources of the first subset of neighboring light sources are different from the light sources of the second subset of neighboring light sources. Similarly, the control circuit 140 may be configured to control the emission times of the light sources such that during a third, fourth, etc. scan cycle only a third, fourth, etc. subset of consecutive light sources of the linear array of light sources simultaneously emits their respective light beam for illuminating a third, fourth, etc. sub-portion of the strip-shaped sub-portion 106 of the FoV.

As indicated above, each of the first subset, the second subset, etc. of the consecutive light sources comprises N light sources. Accordingly, the number of light sources in the linear array of light sources is N times the number of light-sensitive sensor elements capable of receiving (configured to receive) reflections from the strip-shaped sub-portion 106 of the FoV 105 at a time. Each of the number of light-sensitive sensor elements is selectively coupleable to a read-out circuit as indicated above. Only a first light-sensitive sensor element of the number of light-sensitive sensor elements is configured to receive reflections from the first sub-portion of the strip-shaped sub-portion 106 of the FoV 105, only a second light-sensitive sensor element of the number of light-sensitive sensor elements is configured to receive reflections from the second sub-portion of the strip-shaped sub-portion 106 of the FoV 105, etc. Therefore, only the first light-sensitive sensor elements is coupled to the read-out circuit during the first scan cycle, only the second light-sensitive sensor elements is coupled to the read-out circuit during the second scan cycle, etc.

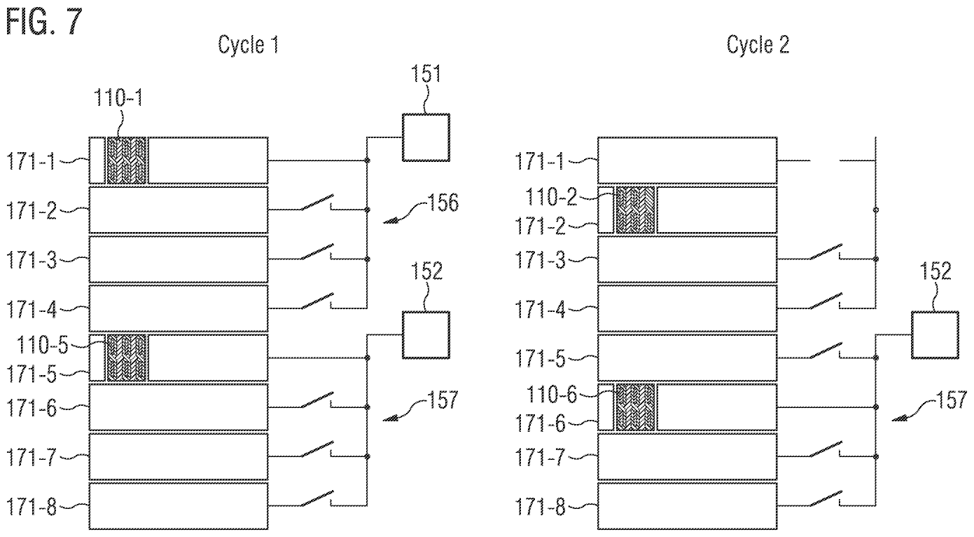

As will be described in the following in connection with FIG. 7, multiple read-out circuits may be used for reading-out the plurality of light-sensitive sensor elements. FIG. 7 illustrates the photodetector 170 and the received reflections from the environment 190 in the FoV 105 for two out of four consecutive scan cycles.

In the example of FIG. 7, the control circuit 140 is configured to control the emission times of the light sources 110-1, . . . , 110-8 such that during a first scan cycle only a first light source 110-1 and a second light source 110-5 of the linear array of light sources 110-1, . . . , 110-8 simultaneously emit their respective light beam for illuminating a first pair of sub-portions of the strip-shaped sub-portion 106 of the FoV 105.

Similarly, the control circuit 140 is configured to control the emission times of the light sources 110-1, . . . , 110-8 such that during a second scan cycle only a third light source 110-2 and a fourth light source 110-6 of the linear array of light sources simultaneously 110-1, . . . , 110-8 emit their respective light beam for illuminating a second pair of sub-portions of the strip-shaped sub-portion 106 of the FoV 105.

Analogously, the control circuit 140 controls the emission times of the light sources 110-1, . . . , 110-8 such that only the light sources 110-3 and 110-7 fire during a third scan cycle, and that only the light sources 110-4 and 110-8 fire during a fourth scan cycle.

As is evident from the above explanations, three light sources of the linear array of light sources 110-1, . . . , 110-8 are arranged between the light sources fired in the respective scan cycle. For example, the three light sources 110-2, 110-3 and 110-4 of the linear array of light sources 110-1, . . . , 110-8 are arranged between the first light source 110-1 and the second light source 110-5 fired in the first scan cycle. However, the number of light sources arranged between the fired light sources may vary depending on the implementation. In general, at least one light source of the linear array of light sources (that is not fired) is arranged between the light sources fired in the respective scan cycle.

All light-sensitive sensor elements 171-1, . . . , 171-8 are capable of receiving reflections from the solid angle in which the object 191, which is reflecting the light beams of the individual light sources fired during the four scan cycles, is located. That is, the number of light-sensitive sensor elements capable of receiving (configured to receive) reflections from the strip-shaped sub-portion 106 of the FoV 105 is equal to the (total) number of fired light sources.

Each of the of light-sensitive sensor elements 171-1, . . . , 171-4 is selectively and individually coupleable to a first read-out circuit 151 via a first switching circuit 156. Each of the of light-sensitive sensor elements 171-5, . . . , 171-8 is selectively and individually coupleable to a second read-out circuit 152 via a second switching circuit 157. In other words, each light-sensitive sensor element of a first portion of the number of light-sensitive sensor elements capable of receiving reflections from the light beams of the linear array of light sources 110-1, . . . , 110-8 is selectively coupleable to the first read-out circuit 151, and each light-sensitive sensor element of a second portion of the number of light-sensitive sensor elements capable of receiving reflections from the light beams of the linear array of light sources 110-1, . . . , 110-8 is selectively coupleable to the second read-out circuit 152.

As indicated in FIG. 7, only the light-sensitive sensor elements 171-1 and 171-5 of the light-sensitive sensor elements 171-1, . . . , 171-8 are capable of receiving (configured to receive) reflections from the first pair of sub-portions of the strip-shaped sub-portion 106 of the FoV 105. That is, only the light-sensitive sensor elements 171-1 and 171-5 receives reflection of the light beams 111-1 and 111-5 from the object 191 during the first scan cycle.

Similarly, only the light-sensitive sensor elements 171-2 and 171-6 of the light-sensitive sensor elements 171-1, . . . , 171-8 are capable of receiving (configured to receive) reflections from the second pair of sub-portions of the strip-shaped sub-portion 106 of the FoV 105. That is, only the light-sensitive sensor elements 171-2 and 171-6 receive reflections of the light beams 111-2 and 111-6 from the object 191 during the second scan cycle.

In other words, only a first light-sensitive sensor element of the first portion of the number of light-sensitive sensor elements is configured to receive reflections from one of the first pair of sub-portions, and only a first light-sensitive sensor element of the second portion of the number of light-sensitive sensor elements is configured receive reflections from the other one of the first pair of sub-portions. Further, only a different second light-sensitive sensor element of the first portion of the number of light-sensitive sensor elements is configured to receive reflections from one of the second pair of sub-portions, and only a different second light-sensitive sensor element of the second portion of the number of light-sensitive sensor elements is configured to receive reflections from the other one of the second pair of sub-portions.

Analogously, only the light-sensitive sensor elements 171-3 and 171-7 receive reflections of the light beams 111-3 and 111-7 from the object 191 during the third scan cycle, and only the light-sensitive sensor elements 171-4 and 171-8 receive reflections of the light beams 111-4 and 111-8 from the object 191 during the fourth scan cycle.

Therefore, only the light-sensitive sensor elements 171-1 is coupled to the first read-out circuit 151 and only the light-sensitive sensor elements 171-5 is coupled to the second read-out circuit 152 during the first scan cycle. Similarly, only the light-sensitive sensor elements 171-2 is coupled to the first read-out circuit 151 and only the light-sensitive sensor elements 171-6 is coupled to the second read-out circuit 152 during the second scan cycle, only the light-sensitive sensor elements 171-3 is coupled to the first read-out circuit 151 and only the light-sensitive sensor elements 171-7 is coupled to the second read-out circuit 152 during the third scan cycle, and only the light-sensitive sensor elements 171-4 is coupled to the first read-out circuit 151 and only the light-sensitive sensor elements 171-8 is coupled to the second read-out circuit 152 during the fourth scan cycle.

In other words, only the first light-sensitive sensor element of the first portion of the number of light-sensitive sensor elements is coupled to the first read-out circuit 151 during the first scan cycle, only the first light-sensitive sensor element of the second portion of the number of light-sensitive sensor elements is coupled to the second read-out circuit 152 during the first scan cycle, only the second light-sensitive sensor element of the first portion of the number of light-sensitive sensor elements is coupled to the first read-out circuit 151 during the second scan cycle, only the second light-sensitive sensor element of the second portion of the number of light-sensitive sensor elements is coupled to the second read-out circuit 152 during the second scan cycle, etc.

The read-out option illustrated in FIG. 7 enables an interleaved row-multiplexing with one light source per light-sensitive sensor element.

In the example of FIG. 7, each of the eight light-sensitive sensor elements 171-1, . . . , 171-8 “sees” the light beam of a single one of the light sources 110-1, . . . , 110-8 in a respective one of the four scan cycles. However, the proposed technique is not limited thereto. In some examples, a different number of light sources and/or a different number of read-out circuits may be used. Further, a different number of light-sensitive sensor elements may be coupled to a respective one of the read-out circuits. Also, each of the light-sensitive elements may “see” the light beams of more than one of the light sources in a scan cycle. For example, two, three, four or more light beams may be fired onto a single light-sensitive sensor element similar to what is illustrated in FIG. 6.

Speaking more general, the control circuit 140 may be configured to control the emission times of the light sources such that during a first scan cycle only a first subset of light sources of the linear array of light sources simultaneously emits their respective light beam for illuminating first sub-portions of the strip-shaped sub-portion 106 of the FoV 105, and that during a second scan cycle only a second subset of light sources of the linear array of light sources simultaneously emits their respective light beam for illuminating second sub-portions of the strip-shaped sub-portion 106 of the FoV 105. A predefined number N (≥1) of light sources of the linear array of light sources is arranged between each pair of consecutive light sources of the first subset of light sources and each pair of consecutive light sources of the second subset of light sources. Further, the light sources of the first subset of light sources are different from the light sources of the second subset of light sources. The control circuit 140 may be configured to control the emission times of the light sources such that during a third, fourth, etc. scan cycle only a third, fourth, etc. subset of light sources of the linear array of light sources simultaneously emits their respective light beam for illuminating a third, fourth, etc. sub-portion of the strip-shaped sub-portion 106 of the FoV 105 in an analogous manner.

As indicated above, the number of light sources in the linear array of light sources may be equal to or greater than the number of light-sensitive sensor elements capable of receiving reflections from the strip-shaped sub-portion 106 of the FoV 105 at a time. Further, the LIDAR sensor may in general comprise K (≥2) read-out circuits for the light-sensitive sensor elements. Accordingly the light-sensitive sensor elements may be grouped into K groups of light-sensitive sensor elements such that each light-sensitive sensor element in a group of the K groups of light-sensitive sensor elements is selectively coupleable to a respective read read-out circuit of the K read-out circuits that is assigned to the respective group of the K groups of light-sensitive sensor elements.

As described above, only a respective first light-sensitive sensor element in each of the K groups of light-sensitive sensor elements is capable of receiving reflections (configured to receive) from one or more respective sub-portions of the first sub-portions, only a respective second light-sensitive sensor element in each of the K groups of light-sensitive sensor elements is capable of receiving (configured to receive) reflections from one or more respective sub-portions of the second sub-portions, etc. Therefore, only the respective first light-sensitive sensor element in each of the K groups of light-sensitive sensor elements is coupled to the respective read read-out circuit assigned to the respective group during the first scan cycle, only the respective second light-sensitive sensor element in each of the K groups of light-sensitive sensor elements is coupled to the respective read read-out circuit assigned to the respective group during the second scan cycle, etc.

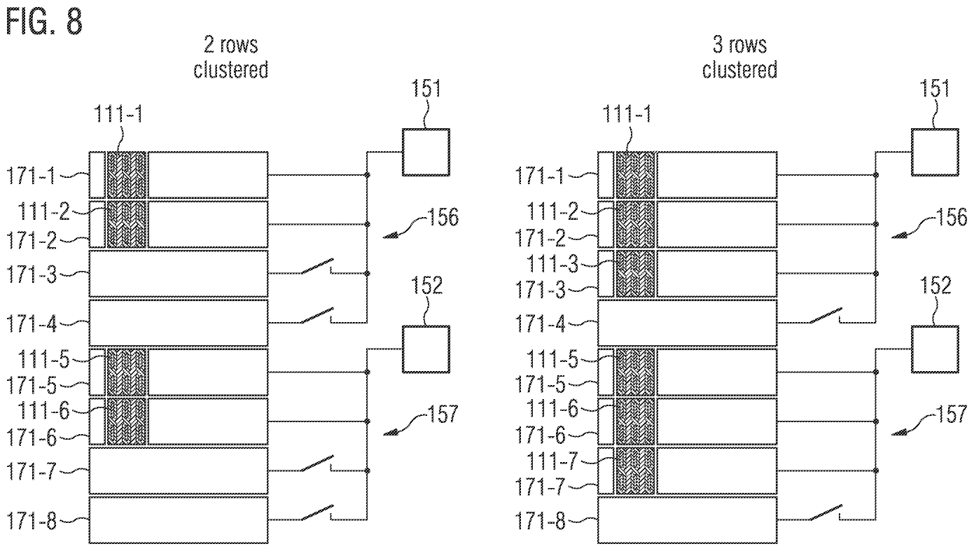

Another read-out option for interleaved row clustering is illustrated in FIG. 8. FIG. 6 illustrates the photodetector 170 and the received reflections from the environment 190 in the FoV 105 for two different row clusters. The left part of FIG. 8 illustrates an example in which two light-sensitive sensor elements are clustered, and the right part of FIG. 8 illustrates an example in which three light-sensitive sensor elements are clustered. FIG. 8 illustrates only one scan cycle for the two types of clustering. However, as will be evident from the following description, the principles described for the one scan cycle illustrated in FIG. 8 may be used as well in further scan cycles.

In the example illustrated in the left part of FIG. 8, the control circuit 140 is configured to control the emission times of the light sources 110-1, . . . , 110-8 such that two consecutive light sources 110-1 and 110-2 of the linear array of light sources simultaneously emit their respective light beam 111-1, 111-2 for illuminating a first sub-portion of the strip-shaped sub-portion 106 of the FoV 105, and that two other consecutive light sources 110-5 and 110-6 of the linear array of light sources simultaneously emit their respective light beam 111-5, 111-6 for illuminating a second sub-portion of the strip-shaped sub-portion 106 of the FoV 105. The two light sources 110-3 and 110-4 of the linear array of light sources 110-1, . . . , 110-8 are not fired and are arranged between the two consecutive light sources 110-1, 110-2 and the two other consecutive light sources 110-5, 110-6. However, the proposed technique is not limited thereto. In general, at least one light source of the linear array of light sources (that is not fired) is arranged between the two pairs of fired light sources.

Similarly, in a consecutive scan cycle, the control circuit 140 may control the emission times of the light sources 110-1, . . . , 110-8 such that two consecutive light sources 110-3 and 110-4 of the linear array of light sources simultaneously emit their respective light beam 111-3, 111-4 for illuminating a third sub-portion of the strip-shaped sub-portion 106 of the FoV 105, and that two other consecutive light sources 110-7 and 110-8 of the linear array of light sources simultaneously emit their respective light beam 111-7, 111-8 for illuminating a fourth sub-portion of the strip-shaped sub-portion 106 of the FoV 105.

In the example in the right part of FIG. 8, the control circuit is configured to control the emission times of the light sources 110-1, . . . , 110-8 such that three consecutive light sources 110-1, 110-2 and 110-3 of the linear array of light sources simultaneously emit their respective light beam 111-1, 111-2, 111-3 for illuminating a first sub-portion of the strip-shaped sub-portion 106 of the FoV 105, and that three other consecutive light sources 110-5, 110-6 and 110-7 of the linear array of light sources simultaneously emit their respective light beam 111-5, 111-6, 111-7 for illuminating a second sub-portion of the strip-shaped sub-portion 106 of the FoV 105. The light source 110-4 of the linear array of light sources 110-1, . . . , 110-8 is not fired and is arranged between the three consecutive light sources 110-1, 110-2, 110-3 and the three other consecutive light sources 110-5, 110-6, 110-7.

All light-sensitive sensor elements 171-1, . . . , 171-8 are capable of receiving reflections from the solid angle in which the object 191, which is reflecting the light beams of the individual light sources, is located. That is, the number of light-sensitive sensor elements capable of receiving reflections from the strip-shaped sub-portion 106 of the FoV 105 is equal to the number of light sources in the linear array of light sources 110-1, . . . , 110-8.

Each of the light-sensitive sensor elements 171-1, . . . , 171-4 is selectively and individually coupleable to a first read-out circuit 151 via a first switching circuit 156. Each of the of light-sensitive sensor elements 171-5, . . . , 171-8 is selectively and individually coupleable to a second read-out circuit 152 via a second switching circuit 157. In other words, each light-sensitive sensor element of a first portion of the number of light-sensitive sensor elements capable of receiving reflections from the light beams of the linear array of light sources 110-1, . . . , 110-8 is selectively coupleable to the first read-out circuit 151, and each light-sensitive sensor element of a second portion of the number of light-sensitive sensor elements capable of receiving reflections from the light beams of the linear array of light sources 110-1, . . . , 110-8 is selectively coupleable to the second read-out circuit 152.

In the example illustrated in the left part of FIG. 8, only the light-sensitive sensor elements 171-1, 171-2, 171-5 and 171-6 of the light-sensitive sensor elements 171-1, . . . , 171-8 are capable of receiving reflections from the first sub-portion and the second sub-portion of the strip-shaped sub-portion 106 of the FoV 105. That is, only the light-sensitive sensor elements 171-1, 171-2, 171-5 and 171-6 receive reflections of the light beams 111-1, 111-2, 111-5 and 111-6 from the object 191 during the scan cycle.

Analogously, only the light-sensitive sensor elements 171-3, 171-4, 171-7 and 171-8 of the light-sensitive sensor elements 171-1, . . . , 171-8 are capable of receiving reflections from the third sub-portion and the fourth sub-portion of the strip-shaped sub-portion 106 of the FoV 105. That is, only the light-sensitive sensor elements 171-3, 171-4, 171-7 and 171-8 receive reflections of the light beams 111-3, 111-4, 111-7 and 111-8 from the object 191 during the following scan cycle.

In the example illustrated in the right part of FIG. 8, only the light-sensitive sensor elements 171-1, 171-2, 171-3 171-5, 171-6 and 171-7 of the light-sensitive sensor elements 171-1, . . . , 171-8 are capable of receiving reflections from the first sub-portion and the second sub-portion of the strip-shaped sub-portion 106 of the FoV 105. That is, only the light-sensitive sensor elements 171-1, 171-2, 171-3 171-5, 171-6 and 171-7 receive reflections of the light beams 111-1, 111-2, 111-3 111-5, 111-6 and 111-7 from the object 191 during the first scan cycle.

Therefore, in the example illustrated in the left part of FIG. 8, only the light-sensitive sensor elements 171-1 and 171-2 are coupled to the first read-out circuit 151 and only the light-sensitive sensor elements 171-5 and 171-6 are coupled to the second read-out circuit 152 during the scan cycle. Similarly, in the example illustrated in the right part of FIG. 8, only the light-sensitive sensor elements 171-1, 171-2 and 171-3 are coupled to the first read-out circuit 151 and only the light-sensitive sensor elements 171-5, 171-6 and 171-7 are coupled to the second read-out circuit 152 during the scan cycle. In other words, only light-sensitive sensor elements of the first portion of the number of light-sensitive sensor elements which are capable of receiving (configured to receive) light from the first sub-portion of the strip-shaped sub-portion 106 of the FoV 105 are coupled to the first read-out circuit 151, and only light-sensitive sensor elements of the second portion of the number of light-sensitive sensor elements which are capable of receiving (configured to receive) light from the sixth sub-portion of the strip-shaped sub-portion 106 of the FoV 105 are coupled to the second read-out circuit 152.

In the example of FIG. 8, each of the eight light-sensitive sensor elements 171-1, . . . , 171-8 “sees” the light beam of a single one of the light sources 110-1, . . . , 110-8 during a respective scan cycle. However, the proposed technique is not limited thereto. In some examples, a different number of light sources and/or a different number of read-out circuits may be used. Further, a different number of light-sensitive sensor elements may be coupled to a respective one of the read-out circuits. Also, each of the light-sensitive elements may “see” the light beams of more than one of the light sources. For example, two, three, four or more light beams may be fired onto a single light-sensitive sensor element similar to what is illustrated in FIG. 6.

Speaking more general, the control circuit 140 may configured to control the emission times of the light sources such that N (≥2) subsets of consecutive light sources of the linear array of light sources simultaneously emit their respective light beams for illuminating N sub-portions of the strip-shaped sub-portion 106 of the FoV 105. As indicated above, the number of light sources in the linear array of light sources may be equal to or greater than the number of light-sensitive sensor elements capable of receiving reflections from the strip-shaped sub-portion 106 of the FoV 105 at a time. Further, the LIDAR sensor may in general comprise K (≥2) read-out circuits for the light-sensitive sensor elements. Accordingly, the light-sensitive sensor elements may be grouped into K groups of light-sensitive sensor elements such that each light-sensitive sensor element in a group of the K groups of light-sensitive sensor elements is selectively coupleable to a respective read read-out circuit of the K read-out circuits that is assigned to the respective group of the K groups of light-sensitive sensor elements.

As described above, (only) a predefined subset of the light-sensitive sensor elements in each of the K groups of light-sensitive sensor elements is capable of receiving (configured to receive) reflections from respective sub-portions of the N sub-portions of consecutive light sources. Therefore, only the predefined subset of the light-sensitive sensor elements in each of the K groups of light-sensitive sensor elements is coupled to the respective read read-out circuit assigned to the respective group.

Further, the control circuit 140 may be configured to control the emission times of the light sources such that N different subsets of consecutive light sources of the linear array of light sources simultaneously emit their respective light beams for illuminating N different sub-portions of the strip-shaped sub-portion 106 of the FoV 105 during another (e.g. consecutive second) scan cycle. Accordingly, a different predefined subset of the light-sensitive sensor elements in each of the K groups of light-sensitive sensor elements is capable of receiving (configured to receive) reflections from respective sub-portions of the N different sub-portions. Therefore, only the predefined subset of the light-sensitive sensor elements in each of the K groups of light-sensitive sensor elements is coupled to the respective read read-out circuit assigned to the respective group during the other scan cycle.

It is to be noted that although one-dimensional arrays of light-sensitive sensor elements are illustrated in FIGS. 1 to 8, the proposed technology may analogously be used with two-dimensional arrays of light-sensitive sensor elements.

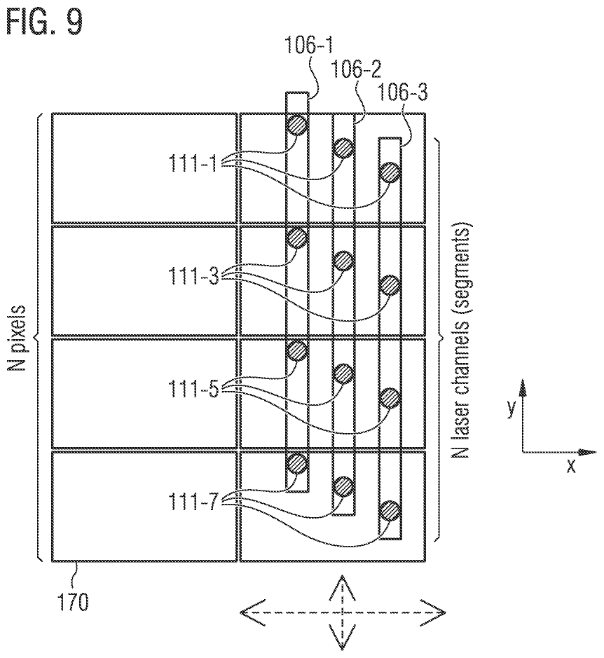

Another scan pattern for the LIDAR sensor 100 is illustrated in FIG. 9. FIG. 9 illustrates the photodetector 170 and the received reflections from the environment 190 in the FoV 105 for three consecutive scan cycles.

In the example of FIG. 9, the control circuit 140 is configured to control the emission times of the light sources 110-1, . . . , 110-8 such that only a subset of light sources of the linear array of light sources 110-1, . . . , 110-8 simultaneously emits their respective light beam 111-1, . . . , 111-8. A predefined number N of light sources of the linear array of light sources 110-1, . . . , 110-8 is arranged between each pair of consecutive light sources of the subset of light sources. In other words, the strip-shaped sub-portion 106 of the FoV 105 is only partly illuminated by the LIDAR sensor 100.

This is illustrated in FIG. 9 for three consecutive scan cycles. Reference number 106-1 denotes the strip-shaped sub-portion 106 of the FoV 105 during the first scan cycle, reference number 106-2 denotes the strip-shaped sub-portion 106 of the FoV 105 during the second scan cycle, and reference number 106-3 denotes the strip-shaped sub-portion 106 of the FoV 105 during the third scan cycle. As can be seen from FIG. 9, the strip-shaped sub-portion 106 of the FoV 105 is not fully illuminated. Only four sub-portions of the strip-shaped sub-portions 106-1, 106-2, 106-3 of the FoV 105 are illuminated during the three scan cycles.

In order to achieve the illustrated illumination pattern, the control circuit 140 controls the emission times of the light sources 110-1, . . . , 110-8 such that the light sources 110-1, 110-3, 110-5 and 110-7 of the linear array of light sources 110-1, . . . , 110-8 simultaneously emit their respective light beam 111-1, 111-3, 111-5, 111-7. That is, one light source of the linear array of light sources 110-1, . . . , 110-8 which is not fired is arranged between each pair of consecutive light sources of the fired light sources 110-1, 110-3, 110-5 and 110-7.

The deflection system 120 is configured to deflect the light beams 111-1, 111-3, 111-5, 111-7 into the FoV 105 such that during the first scan cycle the light beams 111-1, 111-3, 111-5, 111-7 illuminate the FoV 105 at constant first positions along the spatial axis y and at varying positions along the other spatial axis x (which is perpendicular to the spatial axis y), that during the second scan cycle the light beams 111-1, 111-3, 111-5, 111-7 illuminate the FoV 105 at constant second positions along the spatial axis y and at varying positions along the other spatial axis y, that during the third scan cycle the light beams 111-1, 111-3, 111-5, 111-7 illuminate the FoV 105 at constant third positions along the spatial axis y and at varying positions along the other spatial axis y, etc. The second positions are shifted along the spatial axis y with respect to the first positions, the third positons are shifted along the spatial axis y with respect to the second positions, etc.

The movement of the light beams 111-1, 111-3, 111-5, 111-7 along the spatial axes x and y is indicated in FIG. 9 by the varying positions of the light beams 111-1, 111-3, 111-5, 111-7 on the photodetector 170.

Since the light beams 111-1, 111-3, 111-5, 111-7 illuminate the FoV 105 at the constant first positions along the spatial axis y during the first scan cycle, the positions of the light beams 111-1, 111-3, 111-5, 111-7 on the photodetector 170 along the spatial axis y is constant during the first scan cycle. Since the light beams 111-1, 111-3, 111-5, 111-7 illuminate the FoV 105 at varying positions along the other spatial axis x during the first scan cycle, the positions of the light beams 111-1, 111-3, 111-5, 111-7 on the photodetector 170 along the spatial axis x varies during the first scan cycle. In other words, the light beams 111-1, 111-3, 111-5, 111-7 move on the photodetector 170 along the spatial axis x (e.g. from left to right, or vice versa) but remain at constant positions along the spatial axis y.

Similarly, during the second and third scan cycles, the light beams 111-1, 111-3, 111-5, 111-7 move on the photodetector 170 along the spatial axis x (e.g. from left to right, or vice versa) but remain at constant shifted positions along the spatial axis y. In other words, the positions of the light beams 111-1, 111-3, 111-5, 111-7 are shifted along the spatial axis y for each scan cycle. That is, the light beams 111-1, 111-3, 111-5, 111-7 horizontally scan the FoV 105 line by line in order to scan the entire FoV 105.

Again, it is to be noted that the number of light sources and the number of light-sensitive sensor elements illustrated/used for the description of FIG. 9 are merely exemplary. In general, any number of light sources and any number of light-sensitive sensor elements may be used. Further, although a two-dimensional array of light-sensitive sensor elements is illustrated in FIG. 9, the proposed technology may analogously be used with a one-dimensional array of light-sensitive sensor elements. The resulting pattern sampling density (resolution) of the LIDAR system in y-direction in this case can be higher than the number of detector pixels N. It can be calculated as follows: N*(PixelHeight/SegmentBeamHeight).

The examples as described herein may be summarized as follows:

Some examples relate to a LIDAR sensor. The LIDAR sensor comprises a linear array of light sources each configured to controllably emit a respective light beam for scanning an environment in a FoV. Further, the LIDAR sensor comprises a deflection system configured to deflect the light beams into the FoV according to a two-dimensional scan pattern. The LIDAR sensor additionally comprises a control circuit configured to selectively control emission times of the light sources. The control circuit is configured to always control the light sources to simultaneously or sequentially emit their respective light beam. The light beams illuminate a strip-shaped sub-portion of the FoV when all of the light sources are controlled to simultaneously or sequentially emit their respective light beam. The strip-shaped sub-portion longitudinally extends along a spatial axis, wherein an extension of the strip-shaped sub-portion along the spatial axis is smaller than an extension of the FoV along the spatial axis.

In some examples, the LIDAR sensor further comprises a photodetector capable of receiving reflections of the light beams from the environment, wherein the photodetector is a one-dimensional or two-dimensional array of light-sensitive sensor elements.

According to some examples, the control circuit is configured to control the emission times of the light sources such that all of the light sources simultaneously or sequentially emit their respective light beam for illuminating the strip-shaped sub-portion of the FoV, wherein the number of light-sensitive sensor elements capable of receiving reflections from the strip-shaped sub-portion of the FoV is smaller than the number of the light sources.

In some examples, the number of light sources in the linear array of light sources is an integer multiple of the number of light-sensitive sensor elements capable of receiving reflections from the strip-shaped sub-portion of the FoV.

According to some examples, wherein the control circuit is configured to control the emission times of the light sources such that: during a first scan cycle only a first subset of light sources of the linear array of light sources simultaneously emits their respective light beam for illuminating first sub-portions of the strip-shaped sub-portion of the FoV; and during a second scan cycle only a second subset of light sources of the linear array of light sources simultaneously emits their respective light beam for illuminating second sub-portions of the strip-shaped sub-portion of the FoV, wherein a predefined number N of light sources of the linear array of light sources is arranged between each pair of consecutive light sources of the first subset of light sources and each pair of consecutive light sources of the second subset of light sources, and wherein the light sources of the first subset of light sources are different from the light sources of the second subset of light sources.

In some examples, the number of light sources in the linear array of light sources is larger than the number of light-sensitive sensor elements capable of receiving reflections from the strip-shaped sub-portion of the FoV, and wherein each of the number of light-sensitive sensor elements is configured to receive reflections from: a respective one of the first sub-portions of the strip-shaped sub-portion of the FoV during the first scan cycle; and a respective one of the second sub-portions of the strip-shaped sub-portion of the FoV during the second scan cycle.

According to some examples, the LIDAR sensor further comprises a read-out circuit configured to read out the number of light-sensitive sensor elements in parallel.

In some examples, the number of light sources in the linear array of light sources is equal to or greater than the number of light-sensitive sensor elements capable of receiving reflections from the strip-shaped sub-portion of the FoV; wherein the LIDAR sensor comprises K read-out circuits for the light-sensitive sensor elements; wherein the light-sensitive sensor elements are grouped into K groups of light-sensitive sensor elements; wherein each light-sensitive sensor element in a group of the K groups of light-sensitive sensor elements is selectively coupleable to a respective read read-out circuit of the K read-out circuits that is assigned to the respective group of the K groups of light-sensitive sensor elements; wherein only a respective first light-sensitive sensor element in each of the K groups of light-sensitive sensor elements is capable of receiving (configured to receive) reflections from one or more respective sub-portions of the first sub-portions; wherein only a respective second light-sensitive sensor element in each of the K groups of light-sensitive sensor elements is capable of receiving (configured to receive) reflections from one or more respective sub-portions of the second sub-portions; and wherein only the respective first light-sensitive sensor element in each of the K groups of light-sensitive sensor elements is coupled to the respective read read-out circuit assigned to the respective group during the first scan cycle; and wherein only the respective second light-sensitive sensor element in each of the K groups of light-sensitive sensor elements is coupled to the respective read read-out circuit assigned to the respective group during the second scan cycle.

According to some examples, the control circuit is configured to control the emission times of the light sources such that: during a first scan cycle only a first subset of neighboring light sources of the linear array of light sources simultaneously emits their respective light beam for illuminating a first sub-portion of the strip-shaped sub-portion of the FoV; and during a second scan cycle only a second subset of neighboring light sources of the linear array of light sources simultaneously emits their respective light beam for illuminating a second sub-portion of the strip-shaped sub-portion of the FoV, wherein the light sources of the first subset of neighboring light sources are different from the light sources of the second subset of neighboring light sources.

In some examples, each of the first subset and the second subset of the neighboring light sources comprises N light sources, and wherein the number of light sources in the linear array of light sources is N times the number of light-sensitive sensor elements capable of receiving reflections from the strip-shaped sub-portion of the FoV, wherein each of the number of light-sensitive sensor elements is selectively coupleable to a read-out circuit, wherein only a first light-sensitive sensor element of the number of light-sensitive sensor elements is configured to receive reflections from the first sub-portion of the strip-shaped sub-portion of the FoV, wherein only a second light-sensitive sensor element of the number of light-sensitive sensor elements is configured to receive reflections from the second sub-portion of the strip-shaped sub-portion of the FoV, wherein only the first light-sensitive sensor elements is coupled to the read-out circuit during the first scan cycle, and wherein only the second light-sensitive sensor elements is coupled to the read-out circuit during the second scan cycle.

According to some examples, the control circuit is configured to control the emission times of the light sources such that N subsets of consecutive light sources of the linear array of light sources simultaneously emit their respective light beams for illuminating N sub-portions of the strip-shaped sub-portion of the FoV.

In some examples, the number of light sources in the linear array of light sources is equal to or greater than the number of light-sensitive sensor elements capable of receiving reflections from the strip-shaped sub-portion of the FoV; wherein the LIDAR sensor comprises K read-out circuits for the light-sensitive sensor elements; wherein the light-sensitive sensor elements are grouped into K groups of light-sensitive sensor elements; wherein each light-sensitive sensor element in a group of the K groups of light-sensitive sensor elements is selectively coupleable to a respective read read-out circuit of the K read-out circuits that is assigned to the respective group of the K groups of light-sensitive sensor elements; wherein a predefined number of the light-sensitive sensor elements in each of the K groups of light-sensitive sensor elements is configured to receive reflections from respective sub-portions of the N sub-portions; and wherein only the predefined number of the light-sensitive sensor elements in each of the K groups of light-sensitive sensor elements is coupled to the respective read read-out circuit assigned to the respective group.

In some examples, the control circuit is configured to control the emission times of the light sources such that N different subsets of consecutive light sources of the linear array of light sources simultaneously emit their respective light beams for illuminating N different sub-portions of the strip-shaped sub-portion of the FoV during another scan cycle, wherein a different predefined subset of the light-sensitive sensor elements in each of the K groups of light-sensitive sensor elements is configured to receive reflections from respective sub-portions of the N different sub-portions, and wherein only the predefined subset of the light-sensitive sensor elements in each of the K groups of light-sensitive sensor elements is coupled to the respective read read-out circuit assigned to the respective group during the other scan cycle.

According to some examples, the two-dimensional scan pattern is a Lissajous pattern.

In some examples, the control circuit is configured to control the emission times of the light sources such that only a subset of light sources of the linear array of light sources simultaneously emits their respective light beam, wherein a predefined number N of light sources of the linear array of light sources is arranged between each pair of consecutive light sources of the subset of light sources, and wherein the deflection system is configured to deflect the light beams into the FoV such that: during a first scan cycle the light beams illuminate the FoV at constant first positions along the spatial axis and at varying positions along another spatial axis which is perpendicular to the spatial axis; and during a first scan cycle the light beams illuminate the FoV at constant second positions along the spatial axis and at varying positions along the other spatial axis.

According to some examples, the second positions are shifted along the spatial axis with respect to the first positions.

In some examples, the LIDAR sensor further comprises an optical system arranged between the light sources and the deflection system, wherein the optical system is configured to collimate the light beams.

According to some examples, the deflection system comprises: a first reflective surface configured to oscillate about a first rotation axis; and a second reflective surface configured to oscillate about a second rotation axis, wherein the first reflective surface is configured to deflect the light beams onto the second reflective surface, and wherein the second reflective surface is configured to deflect the light beams into the environment.

In alternative examples, the deflection system comprises a reflective surface configured to oscillate about a first rotation axis and a second rotation axis for deflecting the light beams into the environment.

According to some examples, the linear array of light sources is a multi-channel edge emitter laser comprising a plurality of laser channels constituting the light sources.

Examples according to the proposed concept relate to methods for two-dimensional scanning in a ToF range finder (e.g. with a multi-channel edge emitter laser).

The aspects and features mentioned and described together with one or more of the previously detailed examples and figures may as well be combined with one or more of the other examples in order to replace a like feature of the other example or in order to additionally introduce the feature to the other example.

The description and drawings merely illustrate the principles of the disclosure. Furthermore, all examples recited herein are principally intended expressly to be only for illustrative purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts, -functions, -processes, -operations or -steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

1. A light detection and ranging (LIDAR) sensor, comprising:
a linear array of light sources each configured to controllably emit a respective light beam for scanning an environment in a field of view;
a deflection system configured to deflect the light beams into the field of view according to a two-dimensional scan pattern; and
a control circuit configured to selectively control emission times of the light sources, wherein the control circuit is configured to always control the light sources to simultaneously or sequentially emit their respective light beam,
wherein the light beams illuminate a strip-shaped sub-portion of the field of view when all of the light sources are controlled to simultaneously or sequentially emit their respective light beam, wherein the strip-shaped sub-portion longitudinally extends along a spatial axis, and wherein an extension of the strip-shaped sub-portion along the spatial axis is smaller than an extension of the field of view along the spatial axis.

2. The LIDAR sensor of claim 1, further comprising:
a photodetector configured to receive reflections of the light beams from the environment, wherein the photodetector is a one-dimensional or two-dimensional array of light-sensitive sensor elements.

3. The LIDAR sensor of claim 2, wherein the control circuit is configured to control the emission times of the light sources such that all of the light sources simultaneously or sequentially emit their respective light beam for illuminating the strip-shaped sub-portion of the field of view, and wherein the number of light-sensitive sensor elements capable of receiving reflections from the strip-shaped sub-portion of the field of view is smaller than the number of the light sources.

4. The LIDAR sensor of claim 3, wherein the number of light sources in the linear array of light sources is an integer multiple of the number of light-sensitive sensor elements capable of receiving reflections from the strip-shaped sub-portion of the field of view.

5. The LIDAR sensor of claim 2, wherein the control circuit is configured to control the emission times of the light sources such that:
during a first scan cycle only a first subset of light sources of the linear array of light sources simultaneously emits their respective light beam for illuminating first sub-portions of the strip-shaped sub-portion of the field of view; and
during a second scan cycle only a second subset of light sources of the linear array of light sources simultaneously emits their respective light beam for illuminating second sub-portions of the strip-shaped sub-portion of the field of view,
wherein a predefined number N of light sources of the linear array of light sources is arranged between each pair of consecutive light sources of the first subset of light sources and each pair of consecutive light sources of the second subset of light sources, and
wherein the light sources of the first subset of light sources are different from the light sources of the second subset of light sources.

6. The LIDAR sensor of claim 5, wherein the number of light sources in the linear array of light sources is larger than the number of light-sensitive sensor elements capable of receiving reflections from the strip-shaped sub-portion of the field of view, and wherein each of the number of light-sensitive sensor elements is configured to receive reflections from:
a respective one of the first sub-portions of the strip-shaped sub-portion of the field of view during the first scan cycle; and
a respective one of the second sub-portions of the strip-shaped sub-portion of the field of view during the second scan cycle.

7. The LIDAR sensor of claim 6, further comprising:
a read-out circuit configured to read out the number of light-sensitive sensor elements in parallel.

8. The LIDAR sensor of claim 5, wherein:
the number of light sources in the linear array of light sources is equal to or greater than the number of light-sensitive sensor elements capable of receiving reflections from the strip-shaped sub-portion of the field of view;
the LIDAR sensor comprises K read-out circuits for the light-sensitive sensor elements;
the light-sensitive sensor elements are grouped into K groups of light-sensitive sensor elements;
each light-sensitive sensor element in a group of the K groups of light-sensitive sensor elements is selectively coupleable to a respective read read-out circuit of the K read-out circuits that is assigned to the respective group of the K groups of light-sensitive sensor elements;
only a respective first light-sensitive sensor element in each of the K groups of light-sensitive sensor elements is capable of receiving reflections from one or more respective sub-portions of the first sub-portions;
only a respective second light-sensitive sensor element in each of the K groups of light-sensitive sensor elements is capable of receiving reflections from one or more respective sub-portions of the second sub-portions;
only the respective first light-sensitive sensor element in each of the K groups of light-sensitive sensor elements is coupled to the respective read read-out circuit assigned to the respective group during the first scan cycle; and
only the respective second light-sensitive sensor element in each of the K groups of light-sensitive sensor elements is coupled to the respective read read-out circuit assigned to the respective group during the second scan cycle.

9. The LIDAR sensor of claim 2, wherein the control circuit is configured to control the emission times of the light sources such that:
during a first scan cycle only a first subset of consecutive light sources of the linear array of light sources simultaneously emits their respective light beam for illuminating a first sub-portion of the strip-shaped sub-portion of the field of view; and
during a second scan cycle only a second subset of consecutive light sources of the linear array of light sources simultaneously emits their respective light beam for illuminating a second sub-portion of the strip-shaped sub-portion of the field of view,
wherein the light sources of the first subset of neighboring light sources are different from the light sources of the second subset of neighboring light sources.

10. The LIDAR sensor of claim 9, wherein each of the first subset and the second subset of consecutive light sources comprises N light sources, and wherein the number of light sources in the linear array of light sources is N times the number of light-sensitive sensor elements capable of receiving reflections from the strip-shaped sub-portion of the field of view, wherein each of the number of light-sensitive sensor elements is selectively coupleable to a read-out circuit, wherein only a first light-sensitive sensor element of the number of light-sensitive sensor elements is configured to receive reflections from the first sub-portion of the strip-shaped sub-portion of the field of view, wherein only a second light-sensitive sensor element of the number of light-sensitive sensor elements is configured to receive reflections from the second sub-portion of the strip-shaped sub-portion of the field of view, wherein only the first light-sensitive sensor element is coupled to the read-out circuit during the first scan cycle, and wherein only the second light-sensitive sensor element is coupled to the read-out circuit during the second scan cycle.

11. The LIDAR sensor of claim 2, wherein the control circuit is configured to control the emission times of the light sources such that N subsets of consecutive light sources of the linear array of light sources simultaneously emit their respective light beams for illuminating N sub-portions of the strip-shaped sub-portion of the field of view.

12. The LIDAR sensor of claim 11, wherein:
the number of light sources in the linear array of light sources is equal to or greater than the number of light-sensitive sensor elements capable of receiving reflections from the strip-shaped sub-portion of the field of view;
the LIDAR sensor comprises K read-out circuits for the light-sensitive sensor elements;
the light-sensitive sensor elements are grouped into K groups of light-sensitive sensor elements;
each light-sensitive sensor element in a group of the K groups of light-sensitive sensor elements is selectively coupleable to a respective read read-out circuit of the K read-out circuits that is assigned to the respective group of the K groups of light-sensitive sensor elements;
a predefined subset of the light-sensitive sensor elements in each of the K groups of light-sensitive sensor elements is configured to receive reflections from respective sub-portions of the N sub-portions; and
only the predefined subset of the light-sensitive sensor elements in each of the K groups of light-sensitive sensor elements is coupled to the respective read read-out circuit assigned to the respective group.

13. The LIDAR sensor of claim 12, wherein the control circuit is configured to control the emission times of the light sources such that N different subsets of consecutive light sources of the linear array of light sources simultaneously emit their respective light beams for illuminating N different sub-portions of the strip-shaped sub-portion of the field of view during another scan cycle, wherein a different predefined subset of the light-sensitive sensor elements in each of the K groups of light-sensitive sensor elements is configured to receive reflections from respective sub-portions of the N different sub-portions, and wherein only the predefined subset of the light-sensitive sensor elements in each of the K groups of light-sensitive sensor elements is coupled to the respective read read-out circuit assigned to the respective group during the other scan cycle.

14. The LIDAR sensor of claim 1, wherein the two-dimensional scan pattern is a Lissajous pattern.

15. The LIDAR sensor of claim 1, wherein the control circuit is configured to control the emission times of the light sources such that only a subset of light sources of the linear array of light sources simultaneously emits their respective light beam, wherein a predefined number N of light sources of the linear array of light sources is arranged between each pair of consecutive light sources of the subset of light sources, and wherein the deflection system is configured to deflect the light beams into the field of view such that:
during a first scan cycle the light beams illuminate the field of view at constant first positions along the spatial axis and at varying positions along another spatial axis which is perpendicular to the spatial axis; and
during a first scan cycle the light beams illuminate the field of view at constant second positions along the spatial axis and at varying positions along the other spatial axis.

16. The LIDAR sensor of claim 15, wherein the second positions are shifted along the spatial axis with respect to the first positions.

17. The LIDAR sensor of claim 1, further comprising:
an optical system arranged between the light sources and the deflection system, wherein the optical system is configured to collimate the light beams.

18. The LIDAR sensor of claim 1, wherein the deflection system comprises:
a first reflective surface configured to oscillate about a first rotation axis; and
a second reflective surface configured to oscillate about a second rotation axis,
wherein the first reflective surface is configured to deflect the light beams onto the second reflective surface, and
wherein the second reflective surface is configured to deflect the light beams into the environment.

19. The LIDAR sensor of claim 1, wherein the deflection system comprises a reflective surface configured to oscillate about a first rotation axis and a second rotation axis for deflecting the light beams into the environment.

20. The LIDAR sensor of claim 1, wherein the linear array of light sources is a multi-channel edge emitter laser comprising a plurality of laser channels constituting the light sources.
